(19) United States
(12) Patent Application Publication
(10) Pub. No.: US 2009/0280259 A1
(43) Pub. Date: Nov. 12, 2009

(54) Composition and application process of non-aqueous liquid unmolding product

(76) Inventors: Paulo Roberto Cavalcante, Mairipora-SP (BR); Mario Costa Cavalcante Neto, Sao Paulo-SP (BR); Andre Cavalcante, Guarulhos-SP (BR)

Correspondence Address: Richard B. Klar, 145 Willis Avenue, Mineola, NY, 11501, US

(21) Appl. No.: 12/152,024

(22) Filed: May 12, 2008

(51) Int. Cl. B05D 1/02; C09D 5/00

(52) U.S. Cl. 427/421.1; 106/38.25; 106/38.24

(57) ABSTRACT

A non-aqueous liquid un-molding composition is provided for use in the baking industry and an application method for this composition. The composition of the present application includes oil, wax and an emulsifying agent but no water. As a result the dough excess in the mold edges do not burn resulting in the infiltration of dirt into the bakery product that can cause contamination of the bakery product. A method of applying the compound is provided by sprays, application pistols, as well as of modular pulverization systems that facilitate the performance of automatic pulverization pistols, pulverizing the desired surface in a uniform and accurate way.

### BACKGROUND

1. Field

The present invention relates to a composition used in the bakery industry for preparing surfaces and for an application process of such a composition. In particular, the present invention relates to a non-aqueous liquid un-molding composition and an application method of such a composition.

2. The Related Art

Compositions known as un-molding product or unta-form a [a concentrated liquid mixture used to anoint molds], has the function of decreasing the mold dough adherence, thus facilitating its removal after it is baked.

The application of such compositions can be effected in a number of mold types of different sizes, shapes, and materials, at the production of breads, cakes, pasta in general, among others.

The molds used in the bakery industry are usually coated with a Teflon, glazing, or silicon rubber layer, known anti-adherent materials of the bakery business that are expensive. With their use in frequent batches, the coated layer of the mold suffer from great wearing, thus affecting the finished product that remains glued to the mold during its removal and also makes it possible for the food to receive residues of such material.

Today there are a number of unmolding products often used in the industry of pieces, resins, plastic, and in the production of shapes, models, and epoxy, polyurethane, and polyester system pieces, candles, glasses, cleaning, including the food business. Some examples of such unmolding products are disclosed in documents PI9800396-8 and PI9103325-0. PI9800396-8 refer to the development of a product resulting from polymers, starch, and surface active composition, specifically destined to the unmolding of plastic envelops, advantageously replacing the commonly used polypropylene film. PI9103325-0 refers to a mold or shapes maker for the industry of fiberglass and/or epoxy resins pieces, thus avoiding the incrustation of these shapes.

For the bakery industry, a composition was found, disclosed in document PI0303915-3 describing in its composition vegetable oil, water, carnauba wax, beeswax, soybean lecithin, emulsifying agent, potassium sorbate, and antioxidants. Document DE19924231212 also describes in its composition oil, carnauba wax and ethyl cellulose. In addition to these documents, there is a commercial unmolding product in the market, having the same function of this invention, but composed only by water and refined soybean oil. Both documents PI0303915-3 and DE199242311212 and the unmolding product available in the market have a composition that differs from the one of the present invention and consequently have different actions and results.

The application of the anti-adherent products available in the market is currently done by means of fabrics, sponges, brushes, due to the viscosity and lack of acknowledgement by the application process manufacturers. The application process also requires acknowledgment of the covers used in the molds (Glazing, Silicone rubber, and Teflon), of the product formulation to be applied and the dough type (with a higher or lower degree of sugar).

### SUMMARY

The present invention provides for a non-aqueous liquid un-molding composition for an application method for this composition. The composition of the present application includes oil, wax and an emulsifying agent but no water. As a result the dough excess in the mold edges do not burn resulting in the infiltration of dirt into the bakery product that can cause contamination of the bakery product. The present invention also provides for a method of applying the compound by sprays, application pistols, as well as of modular pulverization systems that facilitate the performance of automatic pulverization pistols, pulverizing the desired surface in a uniform and accurate way.

### DETAILED DESCRIPTION OF THE PREFERRED EMBODIMENT(S)

The un-molding composition or product of the present invention does not contain water. The composition of the present invention contains the following composition with the respective proportions:
oil—20% to 90%
wax—0.01% to 95%
emulsifying agent—0.01% to 35%

The oil can be comestible oil from vegetable or mineral origin. The oil can be a mineral oil, soybean oil, sunflower oil, etc.

The wax can be any vegetable-origin wax. The wax can be carnauba wax, beeswax etc

The emulsifying agent can be comestible. The emulsifying agent can be glyceryl monostearate, polysorbate, and other glyceryl esters of fat acids.

As the composition of the present invention does not contain water, it differs from all the other prior art products in the market. The composition of the present invention does not permit dough excess to burn in the molds edges, called in the market as “cracas” [flutings] due to the fact that it does not contain water. The cracas or flutings cause serious problems of dirt getting into the bakery products and thus creates the risk of contamination of the bakery products.

The unmolding product or composition of the present invention was specially developed to provide accurate applications of the composition through the sue of sprays, application pistols, as well as of modular pulverization systems to facilitate the performance of automatic pulverization pistols, pulverizing the desired surface in an uniform and accurate way. By way of non-limiting illustrative example, the product application of the present invention can be done at a rate of 1.33 g/second at the following operating conditions: Air pressure: 2 BAR; Liquid pressure: 2 BAR; Test duration: 1 minute; Measurer used: flask with graduation of 2 mL; Sewage measured: 86 mL.

In comparison to the products available in the market, the present invention provides an economical solution since a smaller quantity of the product is applied due to its concentration and viscosity, and since there is the possibility of automating the application, less time and employees are needed for the application, in addition to the cleaning of the molds and the whole environment involved.

After the application, a layer is created in the molds surface protecting them and increasing the durability.

All the product components are already used in the food industry, do not cause health injuries, and do not interfere with the final product taste.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What I claim:

1. An un-molding composition for baking products containing:
an oil;
a wax;
and an emulsifying agent

2. The un-molding composition according to claim 1, wherein the oil in the composition has a percentage ranging from 20% to 90%.

3. The un-molding composition according to claim 1, wherein the wax has a percentage in the composition ranging from 0.01% to 95%.

4. The un-molding composition according to claim 1, wherein the emulsifying agent has a percentage in the composition ranging from 0.01% to 35%.

5. The un-molding composition according to claim 1, wherein the oil is comestible oil from vegetable or mineral origin.

6. The un-molding composition according to claim 1, wherein the oil is mineral oil, soybean oil, sunflower oil etc.

7. The un-molding composition according to claim 1, wherein the wax is any vegetable-origin wax.

8. The un-molding composition according to claim 1, wherein the wax is the carnauba wax, beeswax etc.

9. The un-molding composition according to claim 1, wherein the emulsifying agent is comestible.

10. The un-molding composition according to claim 1, wherein the emulsifying agent is glyceryl monostearate, polysorbate, and other glyceryl esters of fat acids.

11. A method for applying the un-molding composition of claim 1, the steps comprising:
applying any one of sprays pistols, modular pulverization systems, or any other kind of automated or manual application of said un-molding composition.
